(19) United States
(12) Patent Application Publication
(10) Pub. No.: US 2006/0261166 A1
(43) Pub. Date: Nov. 23, 2006

(54) Flash programming via LF communication

(75) Inventors: Josef Baumgartner, Voels (AT); Charles F. Muma, Swartz Creek, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/414,025

(22) Filed: Apr. 28, 2006

Related U.S. Application Data
(60) Provisional application No. 60/682,083, filed on May 18, 2005.
(60) Provisional application No. 60/702,522, filed on Jul. 26, 2005.

(51) Int. Cl. G06K 7/08; G07B 15/02

(52) U.S. Cl. 235/451; 235/384

(57) ABSTRACT

An example method of transmitting data on a flash memory device that is associated with a microprocessor includes the generating a low frequency wireless link between a programming device and a flash memory device. Instructions and over data are transmitted over this wireless communication link to the microprocessor and the flash memory device for storage in the flash memory device.

### CROSS REFERENCE TO RELATED APPLICATION

The application claims priority to U.S. Provisional Application Nos. 60/682,083 and 60/702,522 which was filed on May 18, 2005.

### BACKGROUND OF THE INVENTION

This invention generally relates to method of programming a flash memory device for a microprocessor. More particularly, this invention relates to a method of programming a flash memory device through a wireless link.

A flash memory device is a type of electrically erasable programmable read-only memory and is used for non-volatile storage of data. Flash memory is being increasingly used to store execution codes and data in portable electronic products. Many devices require or benefit from periodic programming updates and changes. Typically, updating programming for a flash memory device requires a hardwire connection to another computer. However, in many instances, the flash memory device is assembled within a machine or vehicle where access is limited and difficult.

Further, a connection is required during initial programming of the microprocessor. The physical connection to the microprocessor requires an opening within a housing supporting and protecting the microprocessor. Accordingly, once the microprocessor has been programmed, additional handling and assembly is required. As appreciated, any assembly step or other required handling of the flash memory device and microprocessor can potentially cause damage.

For these and other reasons, it is desirable to design and develop a method of programming a microprocessor that does not require physical connections.

### SUMMARY OF THE INVENTION

An example method of programming a flash memory device includes establishing a low frequency wireless link between a programming computer and a flash memory device and transferring desired codes and data through the wireless link from the programming computer to the flash memory device.

An example flash memory device includes a low frequency antenna. The low frequency antenna receives a low frequency signal from a programming device. The programming device transmits a signal that includes a plurality of codes, instructions or other data to be saved in the flash memory device. The flash memory device is associated with the microcontroller such that the instructions stored in the flash memory device are performed or utilized by the microcontroller as is known.

In some instances the device may be disposed within a vehicle or other location that is difficult to reach. Accordingly, reprogramming or correcting programming utilizing a conventional method requires a hard link. In such instances a hard link may be impractical or difficult to accomplish. The example method utilizes a low frequency wireless link to program the flash memory device. The flash memory device can be powered by energy received from the low frequency antenna. Energy received by the low frequency antenna is stored in an associated charge pump. Low frequency energy received by the antenna charges a charge pump, which is utilized to drive the flash memory device during the programming operation. Once the desired signal has stopped the flash memory device is powered down. However, the instructions that were transmitted to the flash memory device remain and the desired flash programming operation has been completed.

Accordingly, the example method provides for the quick and cost effective programming of a flash memory device without requiring a physical connection.

These and other features of the present invention can be best understood from the following specification and drawings, the following of which is a brief description.

### BRIEF DESCRIPTION OF THE DRAWINGS

FIG. 1 is a schematic illustration of an example vehicle including a flash memory device and a low frequency antenna for receiving signals from a programming device.

FIG. 2 is a schematic representation of an example assembly operation including a programming area for flash programming a flash memory device.

### DETAILED DESCRIPTION OF THE PREFERRED EMBODIMENT

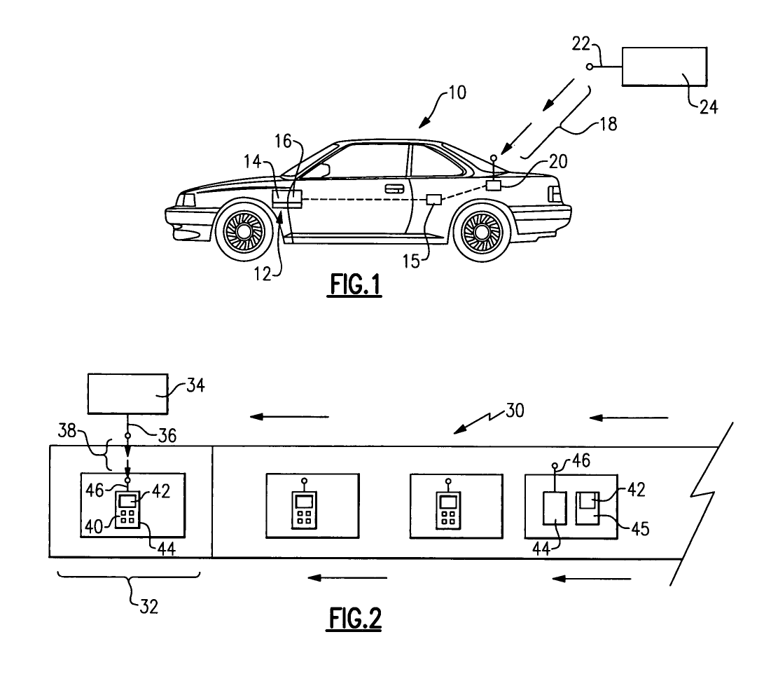

Referring to FIG. 1, an example vehicle 10 is illustrated including a device 12. The device 12 is driven and controlled by a microprocessor 16. Associated with the microprocessor 16 is a flash memory device 14. The flash memory device 14 is an electrically erasable programmable read only memory that is utilized for non-volatile storage of data. The flash memory device 14 is utilized to provide information and programming instructions for the microprocessor 16. The microprocessor 16 and flash memory device 14 are associated with a low frequency antenna 20. The low frequency antenna 20 need not be disposed adjacent the microprocessor 16 and flash memory device 14 but may be disposed in a remote location within the vehicle 10. However, the low frequency antenna 20 may also be disposed as part of the device 12. Accordingly, the position of the low frequency antenna 20 is determined according to application specific requirements and the desired location within a vehicle 10.

A programming device 24 such as a laptop or other computer is associated with a low frequency antenna 22. This low frequency antenna 22 transmits a signal 18. The signal 18 provides for a low frequency wireless link between the low frequency antenna 20 and the low frequency antenna 22. Accordingly, this provides a low frequency link between the programming device 24 and the flash memory device 14. This wireless link provides for the transmission and storage of instructions to the flash memory device 14.

The signal 18 includes a plurality of instructions that are utilized and stored within the flash memory device 14. The example signal 18 comprises a low frequency of approximately 125 kHz, have no other frequencies are also within the contemplation of this invention. The instructions may include those updates to a program required for running the microprocessor 16 and thereby the device 12 but may also include other information as is required or desired to be downloaded and stored in the flash memory device 14.

The low frequency antenna 22 generates the signal 18. Energy from the signal 18 is received by the low frequency antenna 20. The low frequency antenna 20 can be associated with a charging device 15. The charging device 15 can store energy power the flash memory device 14 during programming. When the charging device 15 is utilized, the flash memory device 14 is not required to be powered by an external power source. Instead the required power for programming the flash memory device 14 is supplied entirely by the signal 18. The transmission of power between the programming device 24 and the remotely located flash memory device 14 provides for the programming and download of instructions to the flash memory device 14 without the need for any external connections.

Further, the flash memory device 14 may also be powered by a power source such as a battery within the vehicle 10. The flash memory device 14 may be powered at all times by the vehicle 10 such that power from the low frequency antenna 22 is not required to generate sufficient energy to allow for the desired programming operation.

Referring to FIG. 2, a schematic representation of an assembly operation illustrates an example wireless programming method utilized during assembly of a wireless device. An example assembly line 30 includes sequentially performed assembly operations to produce a wireless device including a microprocessor 45 and a flash memory device 42. The wireless device moves through different assembly operations until finally reaching a programming area 32. The wireless device includes a housing 44 that supports an antenna 46 and a flash memory device 42.

Prior art programming of a flash memory device requires a hard wire connection somewhere during the assembly operation. However, the example method utilizes a wireless link generated between the device 40 and a programming device 34 as the device 40 enters in the programming area 32. In the programming area 32 a signal 38 is generated by the programming device 34 and sent through the low frequency antenna 36 to the device 40. The signal provides and transmits instructions that are stored in the flash memory device 42. These instructions are transmitted over the wireless link and do not require any physical connection. Further, the device 40 can be completely assembled before programming is accomplished.

In the example method power generating by the signal 38 is received by the low frequency antenna 46 of the device 49 and used to power the flash memory device 14 during the programming operation. The transmission of power through the low frequency antenna substantially reduces the number of electrical connections required for powering the device 40 during assembly.

Accordingly, the method of programming disclosed in the illustrated examples utilizes a low frequency wireless link for programming flash memory devices thereby substantially reducing the number of electrical connections and the accompanying hardware that required for programming a flash memory device.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of programming a flash memory device comprising the steps of:
a) generating a low frequency signal from a programming device; and
b) receiving the low frequency signal from the programming device, wherein the low frequency signal includes a program that is stored on the flash memory device.

2. The method as recited in claim 1, wherein step b) includes powering the flash memory device with energy received through a low frequency antenna.

3. The method as recited in claim 2, wherein the low frequency antenna energizes a charge pump and the charge pump provides power for the flash memory device.

4. The method as recited in claim 2, wherein the low frequency antenna is part of the flash memory device.

5. The method as recited in claim 1, wherein the programming device comprises a computer including a low frequency antenna.

6. The method as recited in claim 1, wherein the only external connection to the flash memory device is a wireless low frequency link.

7. The method as recited in claim 1, wherein the flash memory device is installed within a vehicle.

8. The method as recited in claim 7, wherein the low frequency antenna is disposed within the vehicle in a remote location from the flash memory device.

9. The method as recited in claim 1, wherein the low frequency signal comprises a frequency of around 125 KHz.

10. A method of programming a device installed within a vehicle comprising the steps of:
a) generating a low frequency wireless link between a programming device and flash memory device;
b) transmitting instructions for operating a microprocessor associated with the flash memory device from the programming device to the flash memory device through the low frequency wireless link; and
c) storing the instructions for operating the microprocessor in the flash memory device.

11. The method as recited in claim 10, including receiving the low frequency wireless link through a low frequency antenna associated with the flash memory device.

12. The method as recited in claim 11, wherein the low frequency antenna is mounted in a location within the vehicle remote from the flash memory device.

13. The method as recited in claim 12, including the step of powering the flash memory device with power received from the low frequency antenna.

14. A method of initially storing a program within a flash memory device associated with a microprocessor comprising the steps of:
a) defining an area for receiving a low frequency transmission;
b) moving a flash memory device for initial programming into the defined area;
c) establishing a low frequency wireless link between a programming device and the flash memory device; and
d) transferring instructions for operating a microprocessor associated with the flash memory device through the established low frequency wireless link.

15. The method as recited in claim 14, including a low frequency antenna associated with the flash memory device.

16. The method as recited in claim 15, wherein the low frequency antenna receives energy utilized to power the flash memory device and the associated microprocessor during transfer of instructions for operating the microprocessor.

17. The method as recited in claim 14, wherein the low frequency wireless link is the only connection between the programming device and the flash memory device.
